(19) United States
(12) Patent Application Publication
(10) Pub. No.: US 2007/0159148 A1
(43) Pub. Date: Jul. 12, 2007

(54) Power pump

(76) Inventors: George T. Schwab, Kinnelon, NJ (US); Kevin Bolembach, Clifton, NJ (US)

Correspondence Address: Kevin Bolembach;George Schwab, 46 Marlboro Rd, Clifton, NJ, 07012, US

(21) Appl. No.: 11/329,090

(22) Filed: Jan. 11, 2006

(51) Int. Cl. G05F 1/00

(52) U.S. Cl. 323/282

(57) ABSTRACT

The invention is an in-line voltage transformer. The invention converts input voltage from 9 volts to the selected output voltage. The output voltage options are 12, 18 and 24 volts. Thus allowing various signal processor or effects (requiring different voltages) to be powered from the same voltage source. The invention works in conjunction with a digital 12 volt power supply. The input voltage (9V) passes through a filter comprised of two capacitors C1 (1 μF) for low frequencies and C2 (1 μF) for high frequencies. The current then goes into a constant frequency (1.2 MHz) current mode boost switching regulator controlled by U1. The VC pin on U1 provides loop frequency compensation [comprised of C5 (100 pF), C7 (6800 pF) and R4 (6.8K 1%)]. This compensation reduces the output voltage ripple. U1 uses L1 (high frequency 10 μH inductor) and D1 (low drop, high frequency schottky diode) to step the voltage up. The output voltage is set via feedback resistors that are switched in and out to provide the different out put voltages. 12V is set by resistor divider path R1 (169K %) in parallel with R3 (191K 1%) and in series with R5(10K 1%). 18K is set by resistor divider path R2 (536K 1%) in parallel with R3 (191K 1%) and in series with R5 (10K 1%). 24V is set by the resistor divider R3 (191K 1%) in series with R5 (10K 1%). The output voltage is filtered by C3 (for low frequencies) and C5 for (high frequencies). The chassis is a two part cylindrical housing made from ABS HB Black resin. Connecting wiring consists of an input connector which consists of a standard polarity (Tip—positive/Barrel—negative) female barrel connector. The wiring is standard coated 16 gauge.

### CROSS REFERENCE TO RELATED PATENTS

NA

### STATEMENT REGARDING FEDERALLY SPONSERED RESEARCH

NA

### REFERENCE TO SEQUENCE LISTING, A TABLE, OR A COMPUTER PROGRAM

NA

### BACKGROUND OF THE INVENTION

In powering musical signal processors for amplified music, some signal processors work off of different voltages. Most processors work off of a 9-volt direct current supply. However, some models work off of higher voltage. Some work off of 12, 18 or 24 volts.

The invention works with in-line power supplies that are powered from a 110 volt source. The commercial digital power supply reduces the voltage from 110 volts to 9 volts. The invention steps the voltage from 9 volts to the selected voltage. The voltage options are 12, 18 and 24 volts. Thus allowing various signal processor or effects (requiring different voltages) to be powered from the same voltage source.

### SUMMARY OF THE INVENTION

The invention allows the ability to provide multiple voltages to their guitar effects or signal processors' setup without having to use more than one power transformer or outlet space to power said effect units.

The object of the invention is to convert 9 volt DC (direct current) and step up the voltage to 12, 18, or 24 volts DC. The output voltage is determined by the position of a three-way switch located on the unit's chassis. Input is standard polarity (Tip +/Barrel −) female barrel connector and output is standard polarity male barrel connector.

The invention is designed to work in conjunction with any 9 volt DC power supply, although output current rating will vary depending on the input current supplied to the unit.

### BRIEF DESCRIPTION OF THE DRAWINGS

FIG. 1 is a drawing of the invention from the top/front perspective. Each arrow points to a specific part of the invention. The first arrow (A) shows the top fastening pin. Moving clockwise around the drawing to arrow B; shows the electronic PCB board with input and output cables. Arrow C shows the bottom chassis. Arrow D shows the bottom fastening pin. Arrow E points to the top chassis.

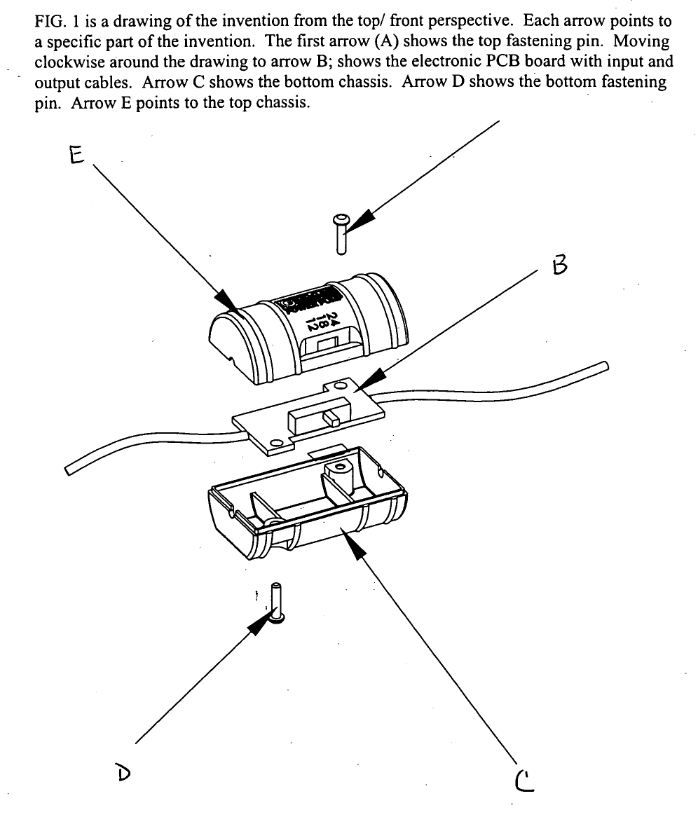

FIG. 2 is an electrical schematic of the PCB board. It is detailed in the abstract as well as the detailed description sections.

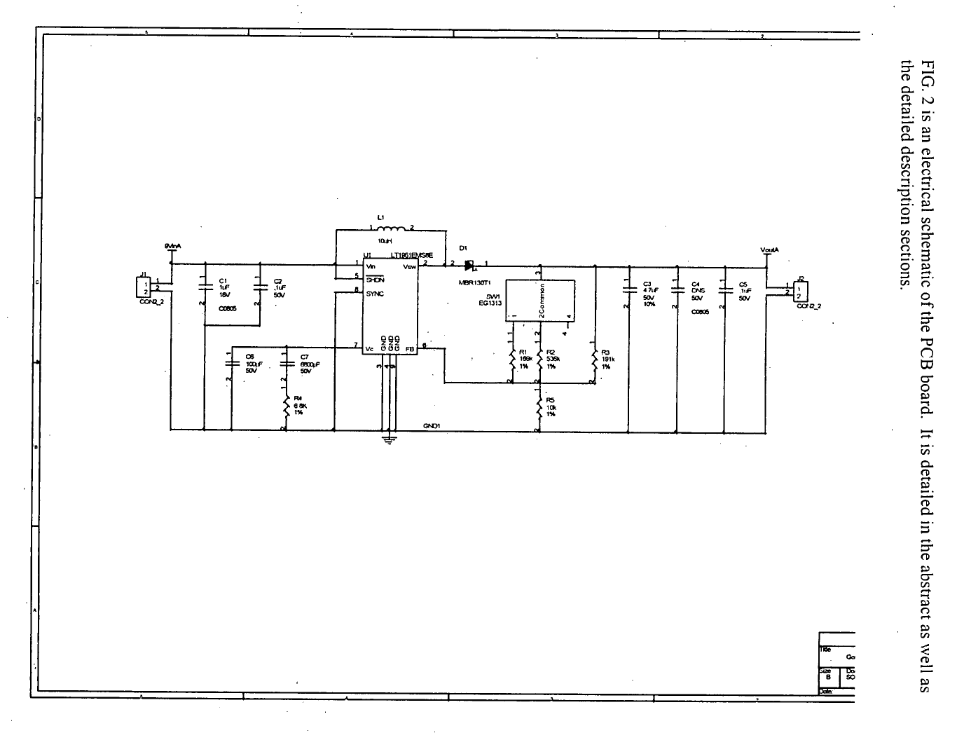

### DETAILED DESCRIPTION OF THE INVENTION

Inside the chassis is a microprocessor which converts the 9-volt input signal.

The input voltage (9V) passes through a filter comprised of two capacitors C1 (1° F.) for low frequencies and C2 (1 μF) for high frequencies. The current then goes into a constant frequency (1.2 MHz) current mode boost switching regulator controlled by U1. The VC pin on U1 provides loop frequency compensation [comprised of C5 (100 pF), C7 (6800 pF) and R4 (6.8K 1%)]. This compensation reduces the output voltage ripple. U1 uses L1 (high frequency 10 μH inductor) and D1 (low drop, high frequency schottky diode) to step the voltage up. The output voltage is set via feedback resistors that are switched in and out to provide the different output voltages. 12V is set by resistor divider path R1 (169K %) in parallel with R3 (191K 1%) and in series with R5 (10K 1%). 18K is set by resistor divider path R2 (536K 1%) in parallel with R3 (191K 1%) and in series with R5 (10K 1%). 24V is set by the resistor divider R3 (191K 1%) in series with R5 (10K 1%). The output voltage is filtered by C3 (for low frequencies) and C5 for (high frequencies).

The chassis is a two part cylindrical housing made from ABS HB Black resin.

Its dimensions are approximately:

Length: [20 mm]

Diameter: [7 mm]

The manufacturing of this device is done by placing the appropriate electrical components on the board and connecting as appropriate. The board is then brushed with epoxy and placed in the housing.

Connecting wiring consists of an input connector which consists of a standard polarity (Tip—positive/Barrel—negative) female barrel connector. The wiring is standard coated 16 gauge.

1. We claim the invention to be an in-line voltage transformer to convert 9 volt DC (direct current) and step the voltage to 12, 18, or 24 volts when used in concert with a 12 volt digital power supply. The invention is used for powering varying guitar effect pedals or signal processors with voltages other than 9 volts.
